(19) United States
(12) Patent Application Publication
(10) Pub. No.: US 2024/0273515 A1
(43) Pub. Date: Aug. 15, 2024

(54) COMPUTER METHOD FOR SIMPLIFIED CREATION OF NFTs

(71) Applicant: DOS CENTAVOS, LLC, EVERETT, WA (US)

(72) Inventor: Christopher A. Wiklof, Everett, WA (US)

(21) Appl. No.: 18/419,620

(22) Filed: Jan. 23, 2024

Related U.S. Application Data
(60) Provisional application No. 63/481,179, filed on Jan. 23, 2023.

(51) Int. Cl. G06Q 20/36; G06Q 20/38

(52) U.S. Cl. CPC G06Q 20/3672; G06Q 20/389

(57) ABSTRACT

According to embodiments, computer methods provide simplified methods to create non-fungible tokens (NFTs). In an embodiment, token data fields may be populated with default values. In an embodiment, a digital wallet is provided automatically. In an embodiment, the digital wallet is associated with a collection name. In an embodiment, a token icon may be automatically generated from a payload file. In an embodiment, a file-creating application may be provided with an NFT output option, for example by loading the NFT creation process as a printer driver.

### CROSS-REFERENCE TO RELATED APPLICATIONS

The present application claims priority benefit from U.S. Provisional Patent Application No. 63/481,179, entitled COMPUTER METHOD FOR SIMPLIFIED CREATION OF NFTs,” filed Jan. 23, 2023 (docket number 3034-018-02); which, to the extent not inconsistent with the disclosure herein, is incorporated by reference.

### SUMMARY

According to an embodiment, a computer method for making a non-fungible token (NFT) includes, with a computing device operatively coupled to a computer network, a blockchain node, and a network storage node; driving, via an application program interface (API) and an application platform, an electronic display of a user device to present a “create NFT” graphical user interface (GUI) including at least two controls; the method including displaying, in the “create NFT” GUI, a “file designation” control; receiving a designation of a payload file for attachment to an NFT; establishing at least one default NFT field value; displaying, in the “create NFT” GUI, a “create NFT” control; and, via the “create NFT” control, receiving a “create NFT” command from the user. With the computing device, the designated file is stored at a networked payload file storage address in a storage network at a storage network node. A plurality of token data fields including at least one file storage address and the at least one default field value are populated into a set of fields for a token-making blockchain transaction. A token-making blockchain transaction is broadcast across a plurality of blockchain nodes via the blockchain node to create the NFT disposed in a designated digital wallet associated with the user account.

According to an embodiment, a computer method for making an NFT includes, with a computing device operatively coupled to a computer network, a blockchain node, and a network storage node, driving, via an API and an application platform, an electronic display of a user device to present a “create NFT” GUI including at least two controls, wherein the user has a corresponding user account. The method may include, when the user has not previously made an NFT, automatically creating a designated digital wallet associated with the user account, such as a custodial or non-custodial designated digital wallet. The method may include displaying, in the “create” GUI, a “file designation” control, and with the “file designation” control, receiving a designation of a payload file for attachment to the NFT; establishing at least one default NFT field value; displaying, in the “create” GUI, a “create NFT” control; and, via the “create NFT” control; and receiving a “create NFT” command from the user. The computing device responsively stores the designated file at a networked payload file storage address in a storage network at a storage network node. The computing device may populate a plurality of token data fields including at least one file storage address and the at least one default field value into a set of fields for a token-making blockchain transaction. The token-making blockchain transaction is broadcast across a blockchain via the blockchain node to create the NFT disposed in the designated digital wallet associated with the user account. The method may include automatically creating an NFT icon file derived from the payload file, and populating the NFT icon file into the set of fields.

According to an embodiment, a computer method for making an NFT includes, with a computing device operatively coupled to a computer network, a blockchain node, and a network storage node, driving an electronic display to present a “create-NFT” GUI including at least two controls; displaying, in the “create NFT” GUI, a “file designation” display, automatically creating an NFT icon file derived from a designated file; establishing at least one default NFT field value; displaying, in the “create NFT” GUI, a “create NFT” control; and, via the “create NFT” control, receiving a “create NFT” command from the user. With the computing device, the designated file is stored at a networked payload file storage address (e.g., at a Content Identified storage address, or CID) in a storage network (such as IPFS). A plurality of token data fields including at least one file storage address and the at least one default field value are entered into a set of fields for a token-making blockchain transaction. The method includes broadcasting the token-making blockchain transaction across a blockchain to create the NFT disposed in a designated digital wallet associated with the user account. Automatically creating the NFT icon file may include down-sampling an image or video payload file to create an image having a predetermined size for displaying on an “NFT card”. The method may further include, with a “file designation” control, receiving a designation of the payload file 208 for attachment to the NFT.

According to an embodiment, a computer method for making an NFT output from a computer application running on a network-connected computer includes driving a user electronic display to present an “NFT Output” GUI including one or more file output options, the one or more file output options including an option to create an NFT for carrying a file produced or stored by the computer application. The method may include displaying an “Output Mode” control in the GUI; receiving selection of an NFT-making utility in the “Output Mode” control; receiving, from the computer application, a plurality of NFT data default field values; and displaying one or more output parameter controls in the “NFT Output” GUI. The “NFT Output” GUI may include a displayed “create NFT” control. The method may include receiving actuation of the “create NFT” control by a user, which causes storing the designated file at a networked payload file storage address; populating a plurality of token data fields including at least one file storage address and the plurality of NFT data default field values into a set of fields for a token-making blockchain transaction; and broadcasting the token-making blockchain transaction across a blockchain network the NFT disposed in a designated digital wallet associated with the user. The method may further include displaying, in the “NFT Output” GUI, an image corresponding to the file. In some embodiments, the only command received directly from the user in the “NFT Output” GUI consists of actuation of the “create NFT” control.

According to an embodiment, a computer method for making a non-fungible electronic token (NFT) includes receiving a “create account” command from a new user via a graphical user interface (GUI) displayed on an electronic display; automatically provisioning a hierarchical deterministic (HD) electronic wallet with a name corresponding to a user name specified by the new user; and displaying a first GUI to the new user, the first GUI including a “create NFT GUI” control. The computer method includes receiving an actuation of the “create NFT GUI” control; displaying a “create NFT” GUI to the new user, the “create NFT” GUI including a file selection control and a “create NFT” control and receiving a file selection via the file selection control and receiving actuation of the “create NFT” control from the new user. The method continues without further input from the new user, including automatically creating an NFT icon file corresponding to the file selection, automatically saving the NFT icon file in non-transitory computer memory at an icon file content-identified address (CID) in a content-identified computer storage network, automatically populating a plurality of NFT data fields including the CID, and automatically broadcasting an NFT creation transaction on a blockchain. Automatically broadcasting the NFT creation transaction on the blockchain causes an NFT to be transacted into the automatically provisioned HD wallet.

According to an embodiment, a computer method for making an NFT includes displaying, to a user on an electronic display, a GUI including a control field for receiving a prompt for driving an artificial intelligence (AI) graphics generation engine; receiving, from the user via the GUI, one or more prompts for driving the AI graphics generation engine; generating a graphic image responsive to the one or more prompts; displaying the graphic image to the user via the GUI; displaying a “MAKE NFT” control in the GUI; receiving actuation of the “MAKE NFT” control from the user; automatically populating a file selection control in the same or a different GUI; and automatically making an NFT and placing the NFT into a user electronic wallet.

According to embodiments, non-transitory computer readable media carry computer instructions to cause a computer to execute the computer methods described above.

### BRIEF DESCRIPTION OF THE DRAWINGS

FIG. 1A is a flow chart showing a computer method for providing simplified making of non-fungible tokens (NFTs), according to an embodiment.

FIGS. 1B, 1C, and 1D are flowcharts showing respective method portions of the method for creating the NFT according to the method of FIG. 1A, plus additional steps not shown in FIG. 1A, according to embodiments.

FIG. 2 is a diagram of a “create NFT” graphical user interface (GUI), according to an embodiment.

FIG. 3 is a diagram of a networked computer system for performing computer methods described herein.

FIG. 4 is a flowchart showing a computer method for making an NFT from a computer application, according to an embodiment.

FIG. 5 is a diagram of an “NFT Output” GUI corresponding to display and control elements referenced by the computer method of FIG. 4, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

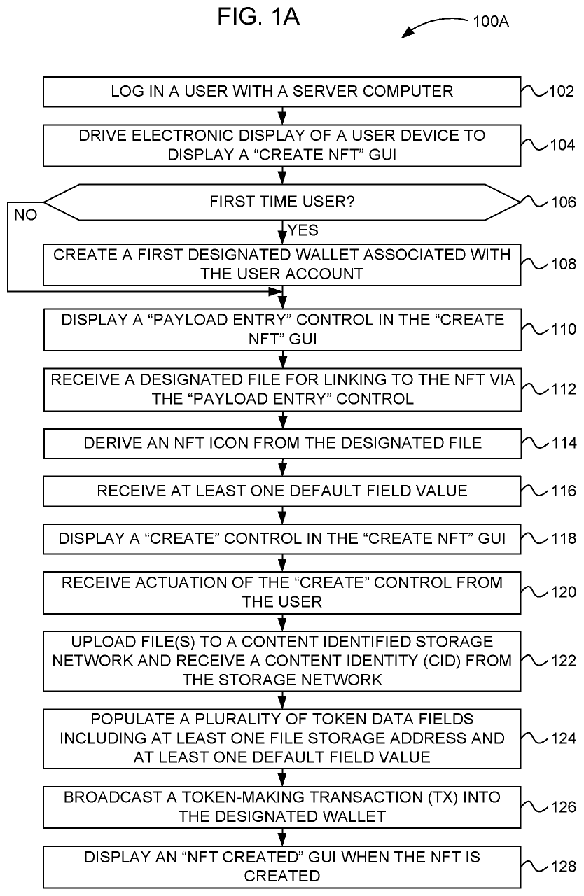

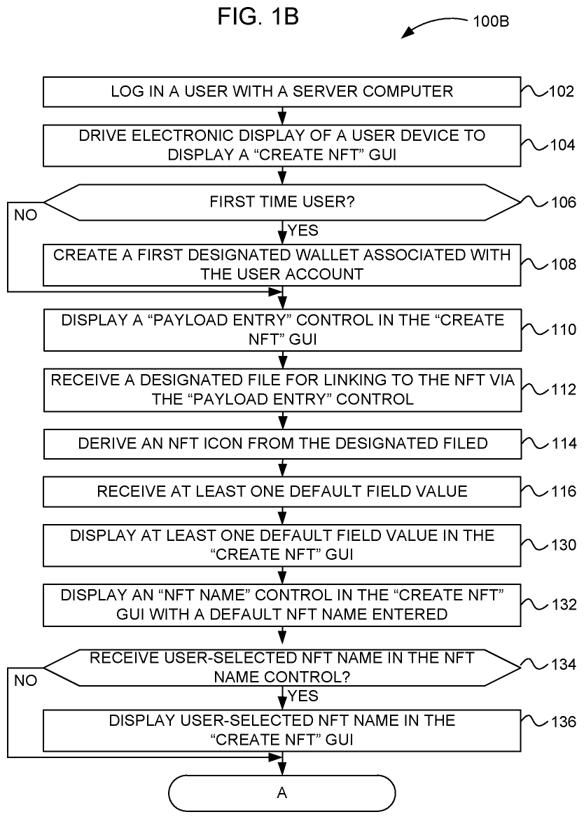

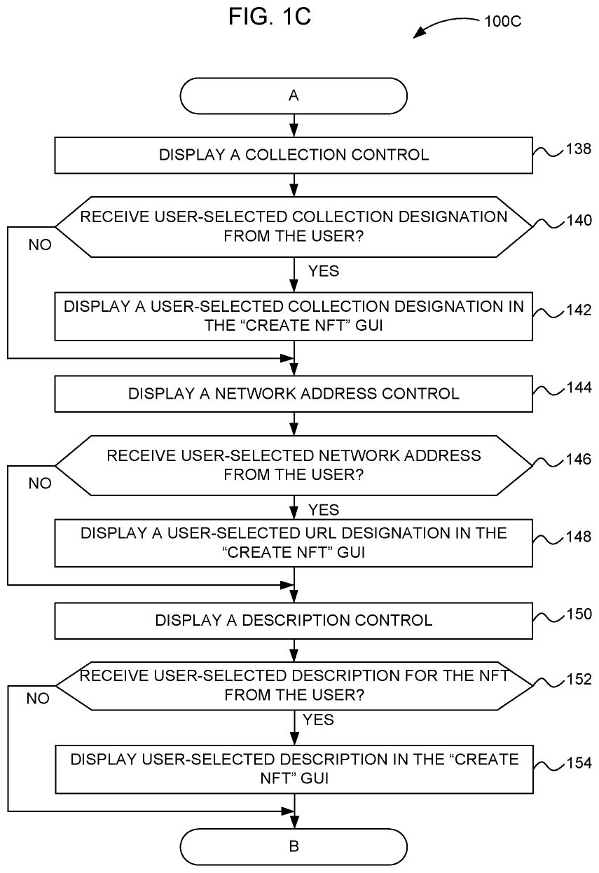

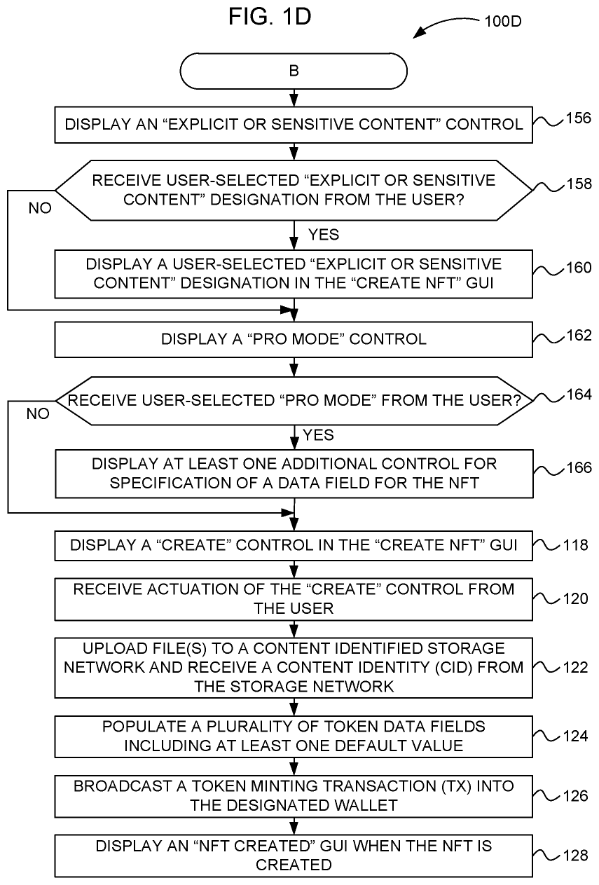

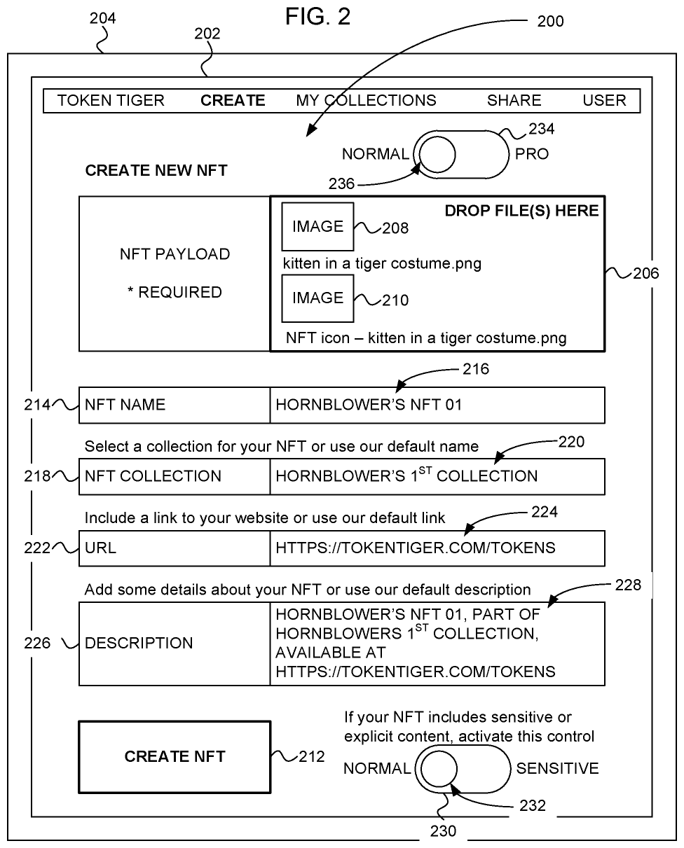

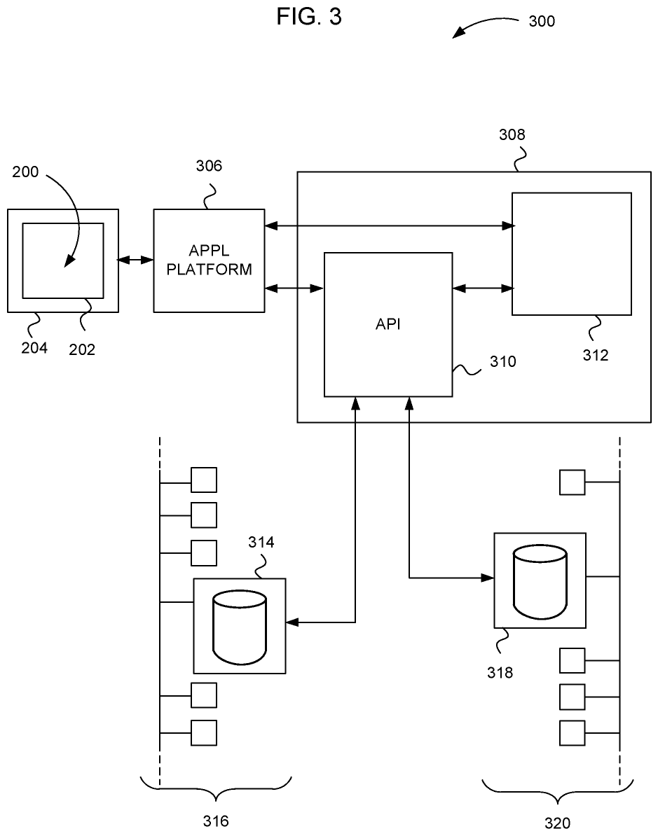

FIG. 1A is a flow chart showing a computer method 100A for providing simplified making of non-fungible tokens (NFTs), according to an embodiment. FIG. 2 is a diagram of a “create NFT” graphical user interface (GUI) 200 referenced by FIGS. 1A-1D, according to embodiments. FIG. 3 is a diagram of a networked computer system 300 for performing computer methods described herein, according to an embodiment.

Referring to FIGS. 1A, 2, and 3, according to embodiments, a computer method 100A for making a non-fungible token (NFT), includes, in step 104, a computing device 308 operatively coupled to a computer network, a blockchain node 314, and a network storage node 318. The computing device 308 drives, via an application program interface (API) 310, an application platform 306, and an electronic display 202 of a user device 204 to present a “create NFT” graphical user interface (GUI) 200, including at least two controls, where the user has a corresponding user account. In decision block 106, if the user account is not new, (e.g., if the user has previously made an NFT,) the method 100A skips to step 110. In step 108, if the user has not previously made an NFT, the method 100A automatically creates a designated digital wallet associated with the user account. Further to step 110, the method 100A displays, in the “create NFT” GUI 200, a “file designation” control 206, and in step 112, with the “file designation” control 206, receives, from the user, a designation of a payload file 208 for attachment to an NFT. Step 114 includes automatically creating an NFT icon file 210 derived from the payload file 208. Step 116 includes establishing at least one default NFT field value 216, 220, 224, 228, 232, 234. Step 118 includes displaying, in the “create NFT” GUI 200, a “create NFT” control 212. In step 120, the “create NFT” GUI 200 receives a “create NFT” command from the user via the “create NFT” control 212. In step 122, the computing device 308 stores the designated payload file at a networked payload file storage address in a storage network 320 at a storage network node 318, and, in step 124, populates a plurality of token data fields including at least one file storage address, and the at least one default NFT field value into a set of NFT fields for a token-making blockchain transaction. Step 126 includes broadcasting the token-making blockchain transaction across a plurality of blockchain 316 nodes via the blockchain node 314 to create the NFT disposed in a designated digital wallet associated with the user account. As used herein, the term “token making” will be understood to be substantially synonymous with “token genesis”, “token minting”, or other approaches for creating a new NFT, unless context indicates to the contrary.

The method 100A may further include, in step 128, displaying an “NFT CREATED” GUI when the token-making blockchain transaction is complete.

According to embodiments, the only commands received directly from the user consist essentially of the designation of the payload file for attachment to the NFT in step 110, and actuation of the “create NFT” command in step 120.

Populating the plurality of token data fields, including the at least one file storage address into the set of fields for the token-making blockchain transaction in step 124 may include storing the payload file at a content identifier (CID) in a content-identified data storage network, where the content-identified data storage network may include the interplanetary file system (IPFS).

Setting at least one data field for the NFT to a default value in step 120 may also include setting respective default values to a plurality of data fields, examples of which are shown in FIGS. 1B, 1C, and 1D. FIGS. 1B, 1C, and 1D include flowcharts showing respective method portions 100B, 100C, 100D of the method 100A for creating the NFT of FIG. 1A, plus additional steps not shown in FIG. 1A, according to embodiments. Referring to FIGS. 1B, 1C, and 1D, in view of FIG. 2 and FIG. 3, according to embodiments, the method 100A further includes driving the electronic display 202 to display the “create NFT” GUI 200, including an “NFT name” control 214, as shown in step 132, where a default value 216 of the “NFT name” control 214 is pre-populated in the “NFT name” control 214. If the user does not enter the user-entered name, the NFT is assigned the default NFT name 206, where the default NFT name 206 is a function of user account information. According to embodiments, the user account information includes an email address associated with the user account, and assigning the default NFT name includes assigning a portion of the email address to the left of an @ symbol prepended to an index number or index number derivation corresponding to a number of NFTs previously-created by the user plus 1. For example, for an email address Horatio9999@tokentiger.com, a first default NFT name may be created as “Horatio9999's 1st NFT”, a second default NFT name may be created as “Horatio9999's 2nd NFT”, etc.

The user account information may include an account name associated with the user account, and assigning the default NFT name may include assigning the account name prepended to an index number or index number derivation corresponding to a number of NFTs previously-created by the user plus 1. For example, for an account name “Hornblower”, a first default NFT name may be created as “Hornblower's 1st NFT”, a second default NFT name may be created “Hornblower's 2nd NFT”, etc.

The method 100A may further include, per step 134, receiving designation of the “NFT name” from the user via the “NFT name” control 214, and, in step 136, displaying the received “NFT name” in the “Create NFT” GUI 200. A data value (default and/or user-designated) in the “NFT name” control 214 may set the “NFT name” associated with a name data field, as outlined in step 124. Proceeding to step 138, the method 100A may further include driving the electronic display 202 to display the GUI 200, including a “Collection” control 218, where the “Collection” control 202 may be pre-populated with a default collection name 220. The default collection name 220 may be set as a function of account information. In step 122, populating the “collection” control 210 with the default first collection name may include deriving a first portion of the default first collection name from the user account information, and deriving a second portion of the default first collection name with an index number or derivative of the index number, the index number corresponding to a number of collections assigned to the user account. The user account information may include an email address associated with the user account, where deriving the default first collection from the user account name may include selecting all or a portion of the email address to the left of an @ symbol in the email address prepended to an index number or index number derivation corresponding to a number of collections previously-created by the user plus 1. For example, for an email address Horatio9999@tokentiger.com, a first default collection name may be created as “Horatio9999's 1st NFT Collection”, a second default collection name may be created as “Horatio9999's 2nd NFT Collection”, etc. The user account name may include a user-entered account name, where deriving the default first collection name from the user account name may include selecting all or a portion of the user-entered account name prepended to an index number or index number derivation corresponding to a number of collections previously-created by the user plus 1. For example, for an account name “Hornblower”, a first default collection name may be created as “Hornblower's 1st NFT Collection”, a second default collection name may be created as “Hornblower's 2nd NFT Collection”, etc.

According to embodiments, if the user does not enter the user-entered collection name, the NFT is assigned to the default collection name 220. If the user does not enter the user-entered collection name, creating the NFT in the designated digital wallet by populating the plurality of token data fields and executing the “make NFT” transaction on the blockchain may include entering the default collection name in a token data field. Executing the “make NFT” transaction may include causing the NFT to be created in the first designated digital wallet associated with the user account.

If the user enters a user-entered collection name different than an existing collection name corresponding to a digital wallet holding at least one NFT, the computing device may execute the steps of automatically creating a second designated digital wallet, associating the user-entered collection name with the second designated digital wallet, and driving display of the second designated digital wallet as the user-entered collection name in the “create NFT” GUI.

According to embodiments, the method 100A further includes receiving designation of a collection name 220 from the user via the “Collection” control 218, as shown in step 140. In step 124, a data value 220 (default and/or user-designated) in the “Collection” control 218 sets a name associated with a “collection name” data field. Responsive to step 126, a data value 220 (default and/or user-designated) in the “Collection” control 218 sets a name associated with the designated digital (aka “electronic”, aka “token”, aka “blockchain”) wallet into which the NFT is deposited. Further, if the collection name is different than a previously designated collection name corresponding to the digital wallet into which at least one previously created NFT, as in step 126, is currently deposited, steps include automatically creating an additional digital wallet, associating the collection name with the additional digital wallet, and designating the additional digital wallet as the designated digital wallet.

According to an embodiment, a data value 220 (default and/or user-designated) in the “Collection” control 218 sets a link to a “parent” token. According to embodiments, creating the NFT includes creating a simple ledger protocol (SLP) “type 65” token, where setting the link to the “parent” token corresponds setting the link to a corresponding SLP “type 128” “group” token.

Populating the plurality of token data fields, shown in step 124, may include inserting the “Collection” data value 220 into the token-making blockchain transaction. Executing the “make NFT” transaction may include causing the NFT to be created in a designated digital wallet corresponding to the collection name 220. In other words, if the collection name 220 is different than a previously designated collection name, an additional digital wallet may be automatically created, and the collection name 220 associated with the additional digital wallet.

The method 100A may further include, in step 144, driving the electronic display 202 to display the “Create NFT” GUI 200, including a network address (aka “URL”) control 222. A default value 224 of the network address control may be set as a function of a URL associated with an application performing the computer method. In step 146, the method 100A may include receiving designation of the network address from the user via the network address control 222, and, in step 148, displaying the user-selected network address in the “Create NFT” GUI 200. A data value 220 (default and/or user-designated) in the network address control may set a network address associated with a URL data field in step 124, included in NFT data. In step 124, creating the NFT may include linking a payload storage location to the network address indicated by the “URL” control. Displaying the network address control 212 in the “create NFT” GUI in step 124 may include displaying the network address control 212 to receive a network address for accessing a website of the user or an organization with which the user is associated. Populating the plurality of token data fields in step 124 may include populating a network address data field independent of where the token payload data is accessed. Creating the NFT in step 124 includes storing the payload file at a content identifier (CID) in a content-identified data storage network, where populating the plurality of token data fields in step 124 includes inserting the payload CID into a token data field.

Step 150 of the method 100A may include driving the electronic display 202 to display a “DESCRIPTION” control 226 in the “create NFT” GUI 200. A default value 228 in the “DESCRIPTION” control 226 may be set as a function of an “NFT name” field 216 (default and/or user-designated) and a “COLLECTION name” field 220 (default and/or user-designated). Optionally, step 150 may include receiving designation of the “DESCRIPTION” from the user via the “DESCRIPTION” control 226. Step 154, may include the description data 228 entered by the user via the description control 226. A data value 228 (default and/or user-designated) in the “DESCRIPTION” control 226 may set a “DESCRIPTION” associated with a “DESCRIPTION” data field included in NFT data, in step 124. Referring to FIG. 1D, the method 100D may include step 156, including driving the electronic display 202 to display the “create NFT” GUI 200, including a “SENSITIVE OR EXPLICIT CONTENT” control 230. The “SENSITIVE OR EXPLICIT CONTENT” control 230 may operate as a toggle and may have a default value 232 set as “FALSE”. The “SENSITIVE OR EXPLICIT CONTENT” control 230 may operate as a toggle and may have a default value 232 set as “TRUE”. Step 158 may further include receiving designation of the “SENSITIVE OR EXPLICIT CONTENT” control 230 from the user via the “SENSITIVE OR EXPLICIT CONTENT” control 230.

Step 162 may include driving the electronic display 202 to display the GUI 200 including a “mode” control 234, where a default value 236 of the “mode” control 234 may be set as “NORMAL”. Step 164 may include receiving designation of an “advanced mode” from the user via the “mode” control 234. Selection of an “advanced mode” (aka, “pro” mode) of the “mode” control 234 in step 164 may cause an “advanced create NFT” GUI or an “advanced” modal to be displayed on the electronic display 202. Selection of an “advanced mode” of the “mode” control 234 may cause, in step 166, display of at least one additional control for specification of the token or an additional data field for loading as part of the set of fields for the token-making blockchain transaction in step 124. Selection of an “advanced mode” of the “mode” control 234 may, for example, include displaying a “schema” control, where a selection of a “schema” option sets a scope and a format of one or more data fields according to an intended use case for the NFT. Selection of a “schema” option may set a scope and a format of one or more data fields for inclusion as “mutable data” data fields. Display of at least one additional control in step 166 may include displaying a “token type” control (not shown). Receiving a “token type” may include receiving a designation of at least one selected from the group consisting of an ERC 721 token, an SLP type 1 token, an SLP type 128 token, an SLP type 65 token, and a CashToken. Selection of a token type may cause selection of one of a plurality of token-making protocols corresponding to the selected token type for broadcasting in step 126.

Displaying at least one additional control in step 166 may include displaying a “blockchain selection” control. According to embodiments, actuation of the “blockchain selection” control includes receiving a designation of at least one selected from the group consisting of an unspent transaction output (UTXO) blockchain, a Bitcoin (BTC) blockchain, a Bitcoin Cash (BCH) blockchain, an Avalanche X-chain (AVAX) blockchain, a blockchain state blockchain; an Etherium-based blockchain, and an Etherium Virtual Machine (EVM) blockchain. Selection of a blockchain may include at least one selected from the group consisting of selection of the designated digital wallet address, selection of a blockchain node for broadcasting the token-making blockchain transaction, a step of converting a token made on a first blockchain (e.g., BCH) to a token output on the selected blockchain, one of a plurality of token-making protocols corresponding to the selected blockchain for broadcasting in step 126, a charge for making the NFT, (e.g., free or a number of purchased or awarded credits), a token type, a contract type, a delay in the broadcast transaction. For example, a cost for making the NFT may be delayed until an offer for sale or a sale of the NFT (referred to as “Lazy Minting” by OpenSea.com).

Displaying at least one additional control in step 166 may include displaying a “contract” control. Actuation of a contract control may include receiving a selection of a predetermined contract name, receiving specification of a network address where contract logic is stored, receiving a designation of a token burning transaction for a download of the payload data file or obtaining access to a physical or virtual place, receiving designation of a receipt token creation transaction for download of the payload data file or for obtaining access to the physical or virtual place, receiving credit of a digital value corresponding to the payload data file, and/or receiving selection of a multi-party digital wallet.

Referring again to FIG. 1A, automatically creating the designated digital wallet associated with the user account in step 108 may include creating a hierarchical deterministic wallet. Additionally or alternatively, automatically creating the designated digital wallet associated with the user account may include creating a custodial blockchain wallet. Automatically creating the designated digital wallet associated with the user account may alternatively include creating a non-custodial blockchain wallet.

Automatically creating the NFT icon file 210 derived from the payload file in step 114 may cause the step of storing the designated file at the payload file networked storage address (in step 122) to includes storing the NFT icon file 210 at an NFT icon file networked file storage address. Populating the plurality of token data fields including the at least one file storage address and the at least one default field value into a set of fields for the token-making blockchain transaction, in step 124, may include populating the NFT icon file networked file storage address into the set of fields.

The method 100A, 100B, 100C, 100D may include, at step 114, automatically creating an NFT icon file 210 derived from the payload file. Storing the designated file at the payload file networked storage address (in step 122) may include storing the NFT icon file 210 at an NFT icon file networked file storage address. Populating the plurality of token data fields including the at least one file storage address and the at least one default field value into a set of fields for the token-making blockchain transaction in step 124 may include populating the NFT icon file networked file storage address into the set of fields.

Receiving the at least one default field value in step 116 may include receiving a schema value, the schema value defining a use of a linking file. The method may thus include creating a linking file such as a Javascript Object Notation (JSON) file and storing the linking file at a linking file networked storage address. Accordingly, populating the plurality of token data fields including the at least one file storage address into the set of fields for the token-making blockchain transaction in step 124 may include populating the linking file networked storage address in the plurality of token data fields.

The method may include, in step 102, with the computing device 308, logging in the user.

Broadcasting the token-making blockchain transaction across a plurality of blockchain 316 nodes via the blockchain node 314 to create the NFT in step 126 may include executing a simple ledger protocol (SLP) type 1 genesis transaction to make an SLP type 1 NFT. Additionally or alternatively, broadcasting the token-making blockchain transaction across a plurality of blockchain 316 nodes via the blockchain node 314 to create the NFT in step 126 includes executing a simple ledger protocol (SLP) type 128 group token genesis transaction, executing an SLP type 65 genesis transaction linked to the SLP type 128 group token, and burning the SLP type 128 group token. In an embodiment, broadcasting the token-making blockchain transaction across a plurality of blockchain 316 nodes via the blockchain node 314 to create the NFT in step 126 includes executing a cashToken genesis transaction to make a cashToken NFT.

In another embodiment, broadcasting the token-making blockchain transaction across a plurality of blockchain 316 nodes via the blockchain node 314 to create the NFT in step 126 includes executing an ERC-721 minting transaction to make an ERC-721 NFT. In another embodiment, broadcasting the token-making blockchain transaction across a plurality of blockchain 316 nodes via the blockchain node 314 to create the NFT in step 126 includes executing a “make NFT” transaction on an unspent transaction output (UTXO) public blockchain. For example, broadcasting the token-making blockchain transaction across a plurality of blockchain 316 nodes via the blockchain node 314 to create the NFT in step 126 may include executing a “make NFT” transaction on a Bitcoin (BTC) blockchain. In another example, broadcasting the token-making blockchain transaction across a plurality of blockchain 316 nodes via the blockchain node 314 to create the NFT in step 126 includes executing a “make NFT” transaction on a Bitcoin Cash (BCH) blockchain. Broadcasting the token-making blockchain transaction across a plurality of blockchain 316 nodes via the blockchain node 314 to create the NFT in step 126 may include executing a “make NFT” transaction on an eCash (XEC) blockchain. Broadcasting the token-making blockchain transaction across a plurality of blockchain 316 nodes via the blockchain node 314 to create the NFT in step 126 may include executing a “make NFT” transaction on an Avalanche X-Chain (AVAX) blockchain. In another embodiment, broadcasting the token-making blockchain transaction across a plurality of blockchain 316 nodes via the blockchain node 314 to create the NFT in step 126 includes executing a “make NFT” transaction on a permissioned blockchain. In other embodiments, broadcasting the token-making blockchain transaction across a plurality of blockchain 316 nodes via the blockchain node 314 to create the NFT in step 126 includes executing a “make NFT” transaction on at least one selected from the group consisting of Polygon, Klaytn, Arbitrum, Optimism, BNB Chain, and Solana. Broadcasting the token-making blockchain transaction across a plurality of blockchain 316 nodes via the blockchain node 314 to create the NFT in step 126 may include executing a “make NFT” transaction on an Etherium Virtual Machine (EVM). Additionally or alternatively, broadcasting the token-making blockchain transaction across a plurality of blockchain 316 nodes via the blockchain node 314 to create the NFT in step 126 may include executing a “make NFT” transaction on an Etherium (ETH) blockchain.

Referring again to FIG. 1A in view of FIGS. 2 and 3, according to an embodiment, a computer method 100A for making a non-fungible token (NFT) includes, in step 104, with a computing device 308 operatively coupled to a computer network, a blockchain node 314, and a network storage node 318, driving, via an application program interface (API) 310 and an application platform 306, an electronic display 202 of a user device 204 to present a “create NFT” graphical user interface (GUI) 200 including at least two controls, wherein the user has a corresponding user account. Proceeding to step 108 (especially when the user has not previously made an NFT), the method 100A includes automatically creating a designated digital wallet associated with the user account.

Step 110 includes displaying, in the “create NFT” GUI 200, a “file designation” control 206. In step 112 with the “file designation” control 206, the method includes receiving a designation of a payload file 208, from the user via the GUI, for attachment to an NFT. Optionally, the method 100A, 100B, 100C, 100D may include step 114, in which an NFT icon file 210 derived from the payload file 208 is automatically created. Step 116 may include establishing at least one default NFT field value 216, 220, 224, 228, 232, 234. Proceeding to step 118, a “create NFT” control 212 may be displayed in the “create NFT” GUI, and, in step 120, via the GUI and the “create NFT” control 212, receiving a “create NFT” command from the user. Responsive to receiving the “create NFT” command, the method proceeds to step 122, where, with the computing device 308, the designated file is stored at a networked payload file storage address in the storage network 320 via the storage network node 318. Proceeding to step 124, a plurality of token data fields including at least one file storage address and the at least one default field value are populated into a set of fields for a token-making blockchain transaction, followed by, in step 126, broadcasting the token-making blockchain transaction across a blockchain 316 via the blockchain node 314 to create the NFT disposed in a designated digital wallet associated with the user account.

As shown in step 128, an “NFT CREATED” GUI may be displayed when the token-making blockchain transaction is complete. A data value (default and/or user-designated) in the “Collection” control 218 may set a name associated with the designated digital (aka “electronic”, aka “token”, aka “blockchain”) wallet into which the NFT is deposited, responsive step 126.

The method may include receiving a new collection name in a “collection” control and, if the collection name is different than the designated digital wallet associated with the user account (such as a previously designated collection name corresponding to the digital wallet into which at least one previously created NFT (created in step 126) is currently deposited), the method may include automatically creating an additional digital wallet, associating the collection name with the additional digital wallet, and designating the additional digital wallet as a currently designated digital wallet.

According to an embodiment, a computer method 100A for making a non-fungible token (NFT) includes, in step 112, with the “file designation” control 206, receiving a designation of a payload file 208 for attachment to an NFT and, in step 114, automatically creating an NFT icon file 210 derived from the payload file 208. In this case, step 122 includes, in addition to storing the designated file at a networked payload file storage address in a storage network 320 at a storage network node 318, storing the automatically created NFT icon file 210 at a networked icon file storage address. Step 124 includes populating a plurality of token data fields including at least one file storage address and the NFT icon file storage address into a set of fields for a token-making blockchain transaction, followed by, in step 126, broadcasting the token-making blockchain transaction across a blockchain 316 via the blockchain node 314 to create the NFT disposed in a designated digital wallet associated with the user account.

Automatically creating the NFT icon file in step 114 may include down-sampling an image or video payload file to create an image or video icon having a predetermined size for displaying on an “NFT card”. The computing device may automatically create the NFT icon 602 by adjusting the size of the payload to fit within a predetermined icon bitmap size.

Optionally, automatically creating the NFT icon file in step 114 includes selecting a predetermined image indicative of a filetype (i.e., extension field) of the payload data file. In another embodiment, automatically creating the NFT icon file, in step 114, includes obtaining an image or indicia specified by the user, specified by a user's employer, specified by a user's educational facility, specified by a user's club, specified by a user's church, specified by a user's professional society, or corresponding to a trademark used in commerce.

Creating the NFT icon file may include obtaining a photograph specified by the user, downsampling or upsampling the photograph, and inserting a bitmap or vector graphics corresponding to the photograph as the NFT icon file. In another embodiment, automatically creating the NFT icon file (in step 114) includes obtaining a location of the user electronic display using a location services utility computer program, obtaining a map having the location centered, and creating the NFT icon file as a bitmap or vector graphic of the map with the location centered.

In another embodiment, automatically creating the NFT icon file (in step 114) includes, upon receiving an indication that the payload file contains sensitive or explicit content from the user via a “SENSITIVE OR EXPLICIT CONTENT” control 230, obtaining a “censored content” or “redacted content” indicia and creating the NFT icon file as a bitmap or vector graphic of the “censored” or “redacted content” indicia.

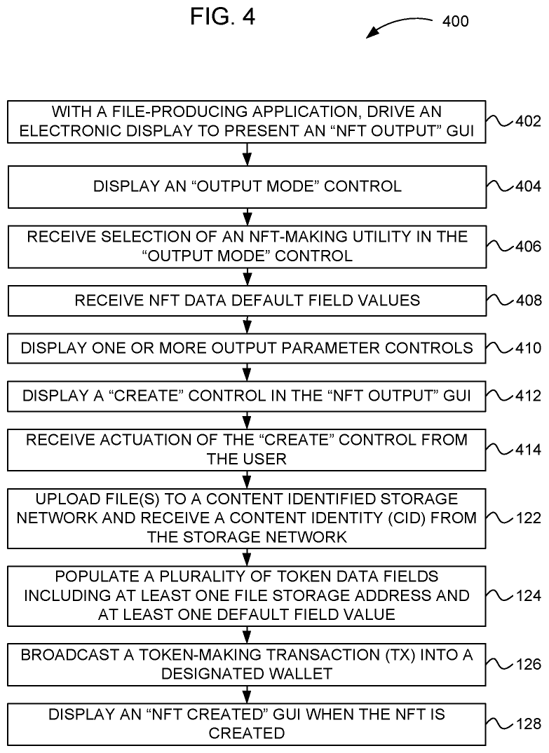

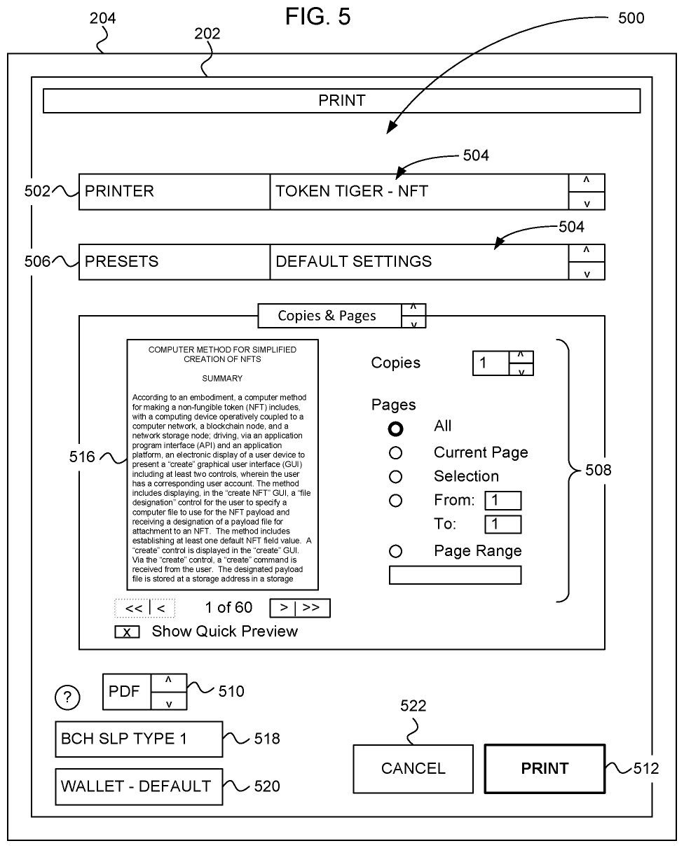

FIG. 4 is a flowchart showing a computer method 400 for making an NFT from a computer application, according to an embodiment. FIG. 5 is a diagram of an “NFT Output” GUI 500 corresponding to display and control elements referenced by the computer method 400 of FIG. 4, according to an embodiment. Optionally, the computer application may be a file-producing computer application.

According to an embodiment, a computer method 400 for making a non-fungible token (NFT) output from a computer application running on a network-connected computer includes, in step 402, with a computing device 204 operatively coupled to a computer network and a blockchain node, driving, from a computer application 306, a user electronic display 202 to present an “NFT Output” GUI 500 including one or more file output options including an option to create an NFT for carrying a file produced by the file-producing computer application. Presenting the “NFT Output” GUI 500 may include, in step 404, displaying an “Output Mode” control 502 in the GUI 500; in step 406, receiving selection of an NFT-making utility 504 in the “Output Mode” control 502; and in step 408, receiving, from the computer application, a plurality of NFT data default field values. The method 400 may include, at step 410, displaying one or more output parameter controls 506, 508, 510 in the “NFT Output” GUI 500; and at step 412, displaying a “create NFT” control 512 in the “NFT Output” GUI 500.

Proceeding to step 414, Actuation of the “create NFT” control 512 by a user is received. Other steps are similar to methods described above, including, in step 122, with a computing device 308, storing the designated file at a networked payload file storage address in a storage network 320 at a storage network node 318; in step 124, populating a plurality of token data fields including at least one file storage address and the plurality of NFT data default field values into a set of fields for a token-making blockchain transaction; and, in step 126, broadcasting the token-making blockchain transaction across a blockchain network 316 via the blockchain node 314 to create the NFT disposed in a designated digital wallet associated with the user.

The method 400 may further include displaying, in the “NFT Output” GUI 500, an image 516 corresponding to the file. The method 400 may include displaying an NFT token and/or blockchain selection control 518. Actuation of the token and/or blockchain selection control 518 by a user may a cause the NFT to be made according to the parameters displayed in the control 518.

The method 400 may further include displaying a wallet selection control 520. Actuation of the wallet selection control 502 may cause the selected wallet to be the designated digital wallet into which the NFT is produced by execution of broadcasting the token-making blockchain transaction (in step 126).

The method 400 may further include displaying a “cancel” control 522. Actuation of the “cancel” control 522 by the user causes the NFT making process to be stopped and causes the electronic display 202 to display the computer application. The “NFT Output” GUI 500 may be configured for outputting only an NFT corresponding to a designated file from an external computer process (e.g., the computer application). According to an embodiment, the only command received directly from the user in the “NFT Output” GUI 500 consists of actuation of the “create NFT” control 512.

According to an embodiment, a computer method for making a non-fungible electronic token (NFT), includes receiving a “create account” command from a new user via a graphical user interface (GUI) displayed on an electronic display; automatically provisioning a hierarchical deterministic (HD) electronic wallet with a name corresponding to a user name specified by the new user; displaying a first GUI to the new user, the first GUI including a “create NFT GUI” control; receiving an actuation of the “create NFT GUI” control; and displaying a “create NFT” GUI to the new user, the “create NFT” GUI including a file selection control and a “create NFT” control. The method includes receiving a file selection via the file selection control and receiving actuation of the “create NFT” control from the new user and, without further input from the new user, automatically creating an NFT icon file corresponding to the file selection, automatically saving the NFT icon file in non-transitory computer memory at an icon file content-identified address (CID) in a content-identified computer storage network, automatically populating a plurality of NFT data fields including the CID, and automatically broadcasting an NFT creation transaction on a blockchain. Automatically broadcasting the NFT creation transaction on the blockchain may cause an NFT to be transacted into the automatically provisioned HD wallet.

The method may further include automatically displaying an NFT card including the NFT icon file via a modal on the electronic display. Receiving the file selection may include receiving selection of an image file, wherein automatically creating the NFT icon file includes thinning the image file to a predetermined resolution.

According to an embodiment, a computer method for making an NFT includes displaying, to a user on an electronic display, a GUI including a control field for receiving a prompt for driving an artificial intelligence (AI) graphics generation engine; receiving, from the user via the GUI, one or more prompts for driving the AI graphics generation engine; generating a graphic image responsive to the one or more prompts; displaying the graphic image to the user via the GUI; and displaying a “MAKE NFT” control in the GUI. The computer method may further include receiving actuation of the “MAKE NFT” control from the user, automatically populating a file selection control in the same or a different GUI, and automatically making an NFT and placing the NFT into a user electronic wallet.

The method may further include displaying a “CREATE NFT” control in the different GUI and receiving actuation of the “CREATE NFT” control by the user. According to embodiments, no additional input from the user is required to make the NFT.

The method may further include displaying a plurality of optional fields to the user in the GUI and receiving user input via at least one of the optional fields in the GUI. In an embodiment, no additional input from the user is required to make the NFT.

According to embodiments, a non-transitory computer readable medium may carry computer instructions to cause a computer to execute any of the methods described herein.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A computer method for making a non-fungible token (NFT), comprising:
with a computing device operatively coupled to a computer network, a blockchain node, and a network storage node, driving, via an application program interface (API) and an application platform, an electronic display of a user device to present a “create NFT” graphical user interface (GUI) 200 including at least two controls, wherein the user has a corresponding user account;
displaying, in the “create NFT” GUI, a “file designation” control;
receiving, from the user via the “file designation” control, a designation of a payload file for attachment to an NFT;
establishing at least one default NFT field value;
displaying, in the “create NFT” GUI, a “create NFT” control;
from the user via the “create NFT” control, receiving a “create NFT” command;
with the computing device, storing the designated payload file on the network storage node;
populating a plurality of token data fields including at least one payload file storage address and the at least one default NFT field value into a set of NFT fields for a token-making blockchain transaction; and
broadcasting the token-making blockchain transaction across a plurality of blockchain nodes via the blockchain node to create the NFT disposed in a designated digital wallet associated with the user account.

2. The computer method for making the NFT of claim 1, further comprising:
displaying an “NFT CREATED” GUI when the token-making blockchain transaction is complete.

3. The computer method for making the NFT of claim 1, wherein the only commands received directly from the user consist essentially of the designation of the payload file for attachment to the NFT and actuation of the “create NFT” command.

4. The computer method for making the NFT of claim 1, wherein populating the plurality of token data fields including the at least one file storage address into the set of fields for the token-making blockchain transaction includes storing the payload file at a content identifier (CID) in a content-identified data storage network.

5. The computer method for making the NFT of claim 4, wherein the content-identified data storage network comprises interplanetary file system (IPFS).

6. The computer method for making the NFT of claim 1, wherein setting at least one data field for the NFT to a default value includes setting respective default values to a plurality of data fields.

7. The computer method for making the NFT of claim 1, further comprising:
driving the electronic display to display the GUI including an “NFT name” control;
wherein a default value of the “NFT name” control is pre-populated in the “NFT name” control; and
wherein the default NFT name is a function of user account information.

8-11. (canceled)

12. The computer method for making the NFT of claim 1, further comprising:
driving the electronic display to display the “create NFT” GUI including a “Collection” control;
wherein the “Collection” control is pre-populated with a default collection name; and
wherein the default collection name is set as a function of account information.

13-16. (canceled)

17. The computer method for making the NFT of claim 12, further comprising:
receiving entry of a collection name from the user via the “Collection” control different than an existing collection name corresponding to a digital wallet holding at least one NFT, the server computer executes the steps of:
automatically creating a second designated digital wallet;
associating the user-entered collection name with the second designated digital wallet; and
driving display of the second designated digital wallet as the user-entered collection name in the “create NFT” GUI.

18-53. (canceled)

54. The computer method for making the NFT of claim 1, further comprising:
automatically creating the designated digital wallet associated with the user account.

55. The computer method for making the NFT of claim 54, wherein
automatically creating the designated digital wallet associated with the user account includes creating a hierarchical deterministic wallet.

56-60. (canceled)

61. The computer method for making the NFT of claim 1, wherein broadcasting the token-making blockchain transaction across a plurality of blockchain nodes via the blockchain node to create the NFT includes executing a simple ledger protocol (SLP) type 1 genesis transaction to make an SLP type 1 NFT.

62-64. (canceled)

65. The computer method for making the NFT of claim 1, wherein broadcasting the token-making blockchain transaction across a plurality of blockchain nodes via the blockchain node to create the NFT includes executing a “make NFT” transaction on an unspent transaction output (UTXO) public blockchain.

66-77. (canceled)

78. A computer method for making a non-fungible token (NFT), comprising:
with a computing device operatively coupled to a computer network, a blockchain node, and a network storage node, driving, via an application program interface (API) and an application platform, an electronic display of a user device to present a “create NFT” graphical user interface (GUI) including at least two controls, wherein the user has a corresponding user account;
displaying, in the “create NFT” GUI, a “file designation” control;
receiving, from the user via the “create NFT” GUI and the “file designation” control, a designation of a payload file for attachment to an NFT;
automatically creating an NFT icon file derived from the payload file;
establishing at least one default NFT field value;
displaying, in the “create NFT” GUI, a “create NFT” control;
via the “create NFT” GUI and the “create NFT” control, receiving a “create NFT” command from the user;
with the computing device, storing the designated payload file at a payload file networked storage address in a storage network via the network storage node;
populating a plurality of token data fields including at least the payload file networked storage address and the at least one default field value into a set of fields for a token-making blockchain transaction; and
broadcasting the token-making blockchain transaction across a blockchain via the blockchain node to create the NFT disposed in a designated digital wallet associated with the user account.

79. The computer method for making the NFT of claim 78, wherein automatically creating the NFT icon file includes adjusting a size of the payload file to create an icon image having a predetermined size for displaying on an “NFT card”.

80-103. (canceled)

104. A computer method for making an NFT, comprising:
displaying, to a user on an electronic display, a GUI including a control field for receiving a prompt for driving an artificial intelligence (AI) graphics generation engine;
receiving, from the user via the GUI, one or more prompts for driving the AI graphics generation engine;
generating a graphic image responsive to the one or more prompts;
displaying the graphic image to the user via the GUI;
displaying a “MAKE NFT” control in the GUI;
receiving actuation of the “MAKE NFT” control from the user;
automatically populating a file selection control in the same or a different GUI;
and automatically making an NFT and placing the NFT into a user electronic wallet.

105. The computer method for making an NFT of claim 104, further comprising:
displaying a “CREATE NFT” control in the different GUI; and
receiving actuation of the “CREATE NFT” control by the user.

106. The computer method for making an NFT of claim 105, wherein no additional input from the user is required to make the NFT.

107. The computer method for making an NFT of claim 105, further comprising:
displaying a plurality of optional fields to the user in the GUI; and
receiving user input via at least one of the optional fields in the GUI.

108. The computer method for making an NFT of claim 104, wherein no additional input from the user is required to make the NFT.

110. (canceled)
